(19) United States
(12) Patent Application Publication
(10) Pub. No.: US 2026/0169750 A1
(43) Pub. Date: Jun. 18, 2026

(54) DEVICE, METHOD AND SYSTEM FOR SPECULATIVE EXECUTION OF A DEPENDENT INSTRUCTION

(71) Applicant: Intel Corporation, Santa Clara, CA (US)

(72) Inventors: Ricardo Daniel Queiros Alves, Hillsboro, OR (US); Mark Dechene, Hillsboro, OR (US)

(73) Assignee: Intel Corporation, Santa Clara, CA (US)

(21) Appl. No.: 18/986,333

(22) Filed: Dec. 18, 2024

(51) Int. Cl. G06F 9/38; G06F 9/30

(52) U.S. Cl. CPC G06F 9/3838; G06F 9/3001; G06F 9/30043; G06F 9/30116; G06F 9/3842

(57) ABSTRACT

Techniques and mechanisms for a processor speculatively execute two load instructions. In an embodiment, a first load instruction and a second instruction are to be executed in parallel with each other by a processor core. A first address operand of the first load instruction identifies a first register, and a second address operand of the second load instruction identifies a second register. A value in the second register is to be calculated based on a load from a memory location which is identified by the value of the first register. Predicted values of the first register and the second register are provided to enable the first load instruction and the second load instruction to be speculatively calculated concurrently with each other. In another embodiment, a verified register value is evaluated, based on a corresponding predicted value, to determine whether a speculative execution is to be interrupted or prevented.

### BACKGROUND

### 1. Technical Field

This disclosure generally relates to processor operations and more particularly, but not exclusively, to the provisioning of predicted operand values for microoperations which are to be executed in parallel.

### 2. Background Art

Processors are variously used for executing one or more macroinstructions. Processors often include one or more execution units (EUs). Typically, a processor having a plurality of execution units includes an out-of-order (OOO) subsystem to use the EUs in an efficient manner. The OOO subsystem may enable more than one microinstruction (uop) to be executed at the same time, although the uops may be executed in a different order than the order in which they were received by the OOO subsystem. Such an OOO subsystem controls the execution of uops by keeping records of the completion of load operations of uops and/or operands and of the dependencies of a certain uop on the completion of previous load operation.

The OOO subsystem also includes a reservation station (RS) to dispatch the uops to the different EUs. Such a RS stores a uop and one or more operands to be used for executing the uop. The RS may transfer a uop, and a corresponding operand, to an EU intended to execute the uop, e.g., when the EU is available, and upon receiving the value of operand. An EU typically executes a uop using an operand received from a register file (RF). In the case of a load operation, one such operand is a source operand, the value of which specifies or otherwise indicates an address of a memory location from which data is to be loaded.

Additional uops which are waiting for data of the same load operation are considered to be dependent on that load operation. A load operation may fail, and in case of a failure the operations which await the data associated with that load operation may need to be identified to be rescheduled for additional data loading. Solutions which check the list of waiting uops to identify which of them need to be rescheduled following the end of every load operation may impose high computational and electrical load on the processor and may therefore slow the operation of the processor and increase its power consumption.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to provide predicted addresses to parallel execution pipelines according to an embodiment.

FIG. 2 shows a flow diagram illustrating features of a method to facilitate parallel execution of microoperations using predicted addresses according to an embodiment.

FIG. 3 shows a block diagram illustrating features of a processor to provide a predicted address value to a dependent microoperation according to an embodiment.

FIG. 4 shows a flow diagram illustrating features of a method to execute a microoperation based on one of a predicted value or a verified value of an address operand according to an embodiment.

FIG. 5 shows a block diagram illustrating features of a processor to selectively provision one of a predicted address or a verified address for a microoperation according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for providing predicted operand values each to a respective one of microoperations which are to be executed in parallel. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor core which supports address prediction functionality.

Some embodiments described herein variously provide predicted address values to facilitate both a speculative execution of a first load instruction and a speculative (and, for example, concurrent) execution of a second load instruction which, with respect to an address operand, depends upon the first load instruction. In an embodiment, the first load instruction and the second load instruction are to be executed by different respective resources of a processor, wherein the resources which are coupled in parallel with each other. In an illustrative scenario according to one embodiment, the first load instruction—e.g., a micro-operation (or “uop”)—comprises a first address operand which identifies a first register, the value of which is to serve as a first address of a first memory location from which information is to be loaded. In an embodiment, the second instruction comprises a second address operand which identifies a second register, the value of which is to serve as a second address of a second memory location from which information is to be loaded. In an embodiment, the value of the second register is to be calculated based on the value of the first register.

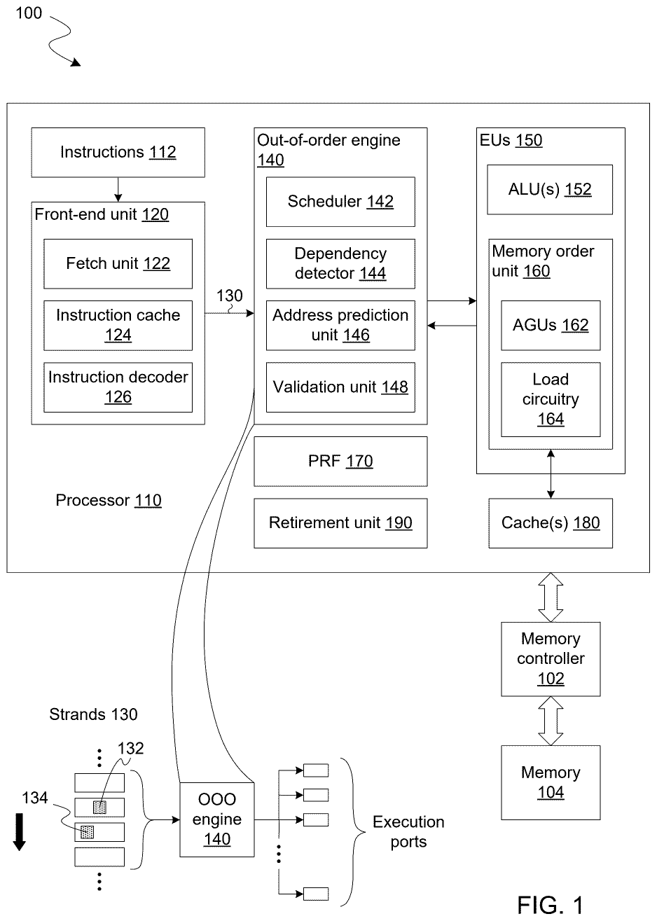

FIG. 1 shows a system 100 which provides a predicted address to parallel execution pipelines according to an embodiment. System 100 illustrates features of one example embodiment wherein the value of an address operand is predicted for an earlier load microoperation (uop) of a uop sequence, and the value of another address operand is predicted for a later load uop of the same sequence. The later load uop is “dependent” on the earlier load uop at least insofar as the later load uop relies upon the earlier load uop to load data from a memory location indicated by the address operand.

As shown in FIG. 1, system 100 comprises a processor 110, a memory 104 and a memory controller 102 which couples processor 110 and memory 104 to each other. Processor 110 comprises a front-end unit 120, execution units (EUs) 150, and an out-of-order engine 140 which is communicatively coupled between front-end unit 120 and EUs 150.

Front-end unit 120 is implemented in any suitable manner. For example, front-end unit 120 comprises a fetch unit 122, instruction cache 124, and instruction decoder 126. Fetch unit 122 fetches instructions from instruction cache 124, memory, or other locations wherein instructions 112 are stored. Fetch unit 122 passes instructions to instruction decoder 126, which disassembles instructions into primitives—e.g., micro-operations (uops) or other such dissembled instructions—for execution.

In an embodiment, front-end unit 120 comprises instruction buffers (not shown) which facilitate the generation of strands based on fetched instructions 112. For example, such instruction buffers are implemented using a queue (e.g., FIFO queue) or any other container-type data structure. In one embodiment, instruction decoder 126 of front-end unit 120 decodes instructions 112 to generate relatively dissembled instructions (e.g., micro-operations, or “uops”) which are variously grouped into strands 130 that are each to be provided to a respective one of EUs 150—e.g., wherein strands 130 each comprise a respective one or more decoded instructions.

In an embodiment, processor 110 comprises a scheduler 142 which is to schedule the execution of various ones of strands 130 each with a respective one of EUs 150. Scheduler 142 is implemented in any suitable portion of processor 110. In one embodiment, scheduler 142 is implemented in out-of-order engine 140. Front-end unit 120 is communicatively coupled to out-of-order engine 140 to pass decoded instructions. Out-of-order engine 140 comprises any of various suitable additional or alternative components to reorder instructions in an out-of-order manner and to allocate resources for execution. Out-of-order engine 140 renames logical resources and map them to physical resources. Such data is stored in a physical register file (PRF) 170, for example. Scheduler 142 issues decoded instructions of strands 130 to various execution units 150.

Execution units 150 execute instructions (e.g., uops) that are received from scheduler 142 and retires them according to elements and logic as stored in a reorder buffer (not shown). Such retirement follows rules to ensure that data-dependency errors resulting from out-of-order execution are prevented. When instructions have executed, and are retired or committed (e.g., with the illustrative retirement unit 190 shown), the results are written to a cache 180, to memory 104, or any other suitable location.

In the example embodiment shown, execution units 150 comprise one or more arithmetic logic units (ALUs) 152, and a memory order unit 160. The execution of any of various arithmetic calculation instructions is performed with ALU(s) 152. By contrast, the performance of any of various load instructions—e.g., instructions to load data from a memory resource into PRF 170—is performed with memory order unit 160.

In an embodiment, memory order unit 160 comprises one or more address generation units (AGUs) 162 to read, calculate or otherwise verify the respective values of address operands each in a respective instruction of strands 130. Furthermore, load circuitry 164 of memory order unit 160 comprises one or more pipelines each for executing a respective load using an address which (for example) is generated by AGU(s) 162.

In various embodiments, an instruction in one of strands 130 is susceptible to being dependent on another instruction in a different one of strands 130. In an illustrative scenario according to one embodiment, load instructions 132, 134 (e.g., load uops) are in different respective ones of strands 130, wherein load instruction 132 precedes dependent load instruction 134 in a program sequence of strands 130, and wherein dependent load instruction 134 is dependent upon load instruction 132. Such dependency results (for example) from the value of an address operand of load instruction 134 being determined based upon the value of another address operand of load instruction 132. Conventionally, such a load instruction dependency imposes constraints on the execution of strands with different respective execution units of a processor.

Certain features of various embodiments are described herein with reference to an illustrative scenario wherein load instruction 132 comprises a first operand which is to indicate a first address of a first memory location from which first information is to be loaded (e.g., into a physical register of PRF 170), and wherein load instruction 134 comprises a second operand which is to indicate a second address of a second memory location from which second information is to be loaded. In the scenario, the first operand identifies a first register, wherein a value in the first register is to be used as the first address. Similarly, the second operand identifies a second register, the value of which is to be used as the second address. Furthermore, the value of the second operand is to be determined based on the first information (and, accordingly, based on the first operand used to load said first information). In one such embodiment, load instructions 132, 134 are to be executed with different respective load pipelines of EUs 150.

To mitigate certain execution constraints of existing processor architectures, some embodiments variously enable the provisioning of a first predicted address value to facilitate the execution of load instruction 132, as well as the provisioning of a second predicted address value to facilitate a concurrent execution of load instruction 134. For example, some embodiments enable both a speculative execution of load instruction 132 and a concurrent speculative execution of dependent load instruction 134—e.g., while one or each of instructions 132, 134 awaits the determining of a respective verified (e.g., correctly read, calculated or otherwise determined) address value to be provided as a substitute for the corresponding predicted address value.

In the example embodiment shown, out-of-order engine 140 further comprises (or, alternatively, is coupled to operate with) a dependency detector 144 which is configured to identify instruction dependencies—e.g., including a dependency of load instruction 134 on load instruction 132. In an example scenario, a first address operand of load instruction 132 identifies a first register as being a repository of a first address of a first location from which first data is to be loaded. By contrast, a second address operand of load instruction 134 identifies a second register as being a repository of a second address of a second location from which second data is to be loaded. A dependency between load instructions 132, 134 is based, for example, on one or more other uops-which are between load instructions 132, 134 in the uop sequence-which are to provide to the second register a value which is based on the value of the first data (and therefore, based on the value in the first register). For example, the one or more other uops include an arithmetic uop which performs a calculation with the first data, wherein second register is a destination register for a (direct or indirect) result of the calculation. Dependency detector 144 provides functionality to detect this relationship between the respective values which the first address operand and the second address operand are to have.

Dependency detector 144 further provides functionality to detect that load instructions 132, 134 are to assigned—e.g., by scheduler 142—be executed in parallel (and in some embodiments, concurrently) with each other by different respective execution paths of EUs 150. By way of illustration and not limitation, dependency detector 144 detects that load instruction 132, 134 are to be executed with different respective load pipelines of load circuitry 164 or, for example, by different respective memory order units of EUs 150.

In one such embodiment, an address prediction unit 146 of processor 110 is coupled to dependency detector 144, wherein address prediction unit 146 generates or otherwise provides a first predicted value for the first address operand of load instruction 132, and further generates or otherwise provides a second predicted value for the second address operand of load instruction 134. In an embodiment, load instruction 132 and dependent load instruction 134 are provided each to a different respective one of execution units 150, wherein address prediction unit 146 provides the first predicted address value a first load buffer of EUs 150 in association with load instruction 132 and further provides the second predicted address value a second load buffer of EUs 150 in association with load instruction 134. In so provisioning the first and second predicted address values, address prediction unit 146 enables an initiation of a load based on a first speculative execution of load instruction 132 using the first predicted address value, and further enables a concurrency of the first speculative execution with a second speculative execution of dependent load instruction 134 using the second predicted address value. It is to be noted, however, that in some embodiments one or both speculative executions are subject to being prevented or stopped—e.g., where one of AGUs 162 generates a corresponding verified address value to enable non-speculative execution before the completion of any such speculative execution based on the predicted address value.

In some embodiments, processor 110 further comprises circuitry (such as the illustrative validation unit 148 shown) which is coupled to receive or otherwise determine a predicted address value that is generated by address prediction unit 146, as well as a corresponding verified address value that is generated with AGUs 162. For example, validation unit 148 identifies a first verified value for the address operand of load instruction 132—e.g., wherein one of AGUs 162 reads, calculates or otherwise verifies said value and provides it to out-of-order engine 140. In one such embodiment, validation unit 148 performs an evaluation to determine whether a corresponding predicted address value provides a correct prediction of the verified address value. Based on such an evaluation, validation unit 148 variously signals whether an address operand value is to be replaced, whether the execution of an instruction is to be stopped, whether processor 110—e.g., at least a core thereof—is to be recovered from a completed instruction execution (such as a speculative execution, if any, of load instruction 132), and/or the like.

In an illustrative scenario according to one embodiment, validation unit 148 detect a condition wherein a speculative execution of load instruction 132 has yet to commence when the evaluation of the first predicted address value for load instruction 132 (based on a corresponding first verified address value) is determined. Based on such a condition, validation unit 148 communicates to one or more signals which indicate—e.g., to memory order unit 160 of execution units 150—that the first predicted address for load instruction 132 is to be replaced with the first verified address to enable a non-speculative execution of load instruction 132 with the first verified address. In one such embodiment, the first verified address replaces the first predicted address in an entry of a load buffer (e.g., at load circuitry 164) where load instruction 132 is buffered while awaiting execution. In one such embodiment, validation unit 148 additionally or alternatively communicates one or more signals to replace a second predicted address with a corresponding second verified address, at a second load buffer, to enable a non-speculative execution of dependent load instruction 134 with the second verified address.

In another illustrative scenario, validation unit 148 detects a condition wherein a speculative execution of load instruction 132 has completed before the evaluation of the first predicted address value for load instruction 132 (based on the corresponding verified address value) is determined. Based on such a condition, validation unit 148 implements either of two responses, according to whether the evaluation indicates a correct prediction of the verified address. For example, where the prediction is determined to be correct, validation unit 148 communicates one or more signals to indicate—e.g., to retirement unit 190 and/or other suitable circuitry of processor 110—that a writeback of the load performed for load instruction 132 is correct. By contrast, where the prediction is determined to be incorrect, validation unit 148 communicates one or more signals instead to initiate a recovery of processor 110 from the speculative execution of load instruction 132 (and, in some embodiments, further to initiate a recovery of processor 110 from the speculative execution of load instruction 134).

In yet one more illustrative scenario, validation unit 148 detects a condition wherein a speculative execution of load instruction 132 is underway when the evaluation of the first predicted address value for load instruction 132 (based on the corresponding first verified address value) is determined. Based on such a condition, validation unit 148 implements either of two responses, according to whether the evaluation indicates a correct prediction of the first verified address. For example, where the prediction is determined to be correct, validation unit 148 communicates one or more signals to indicate that a writeback of the load performed for load instruction 132 is to be permitted. By contrast, where the prediction is determined to be incorrect, validation unit 148 communicates one or more signals instead to interrupt the speculative execution of load instruction 132, replace the first predicted address value with the first verified address value—e.g., at a first load buffer of load circuitry 164—and to enable a non-speculative execution of load instruction 132 with the first verified address value. In one such embodiment, validation unit 148 further communicates one or more signals to interrupt the speculative execution of load instruction 134, replace the second predicted address value with a corresponding second verified address value—e.g., at a second load buffer of load circuitry 164 and to enable a non-speculative execution of load instruction 134 with the second verified address value.

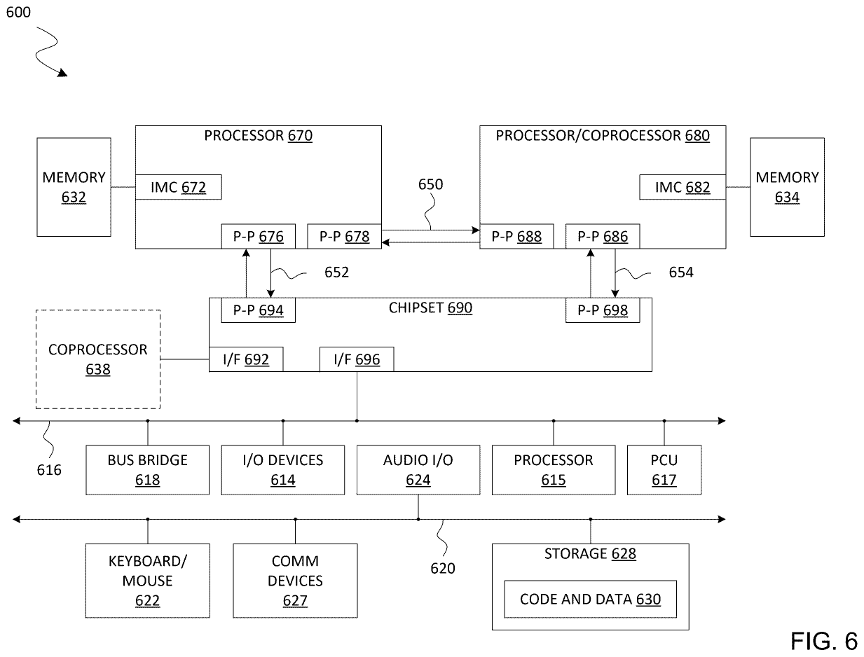

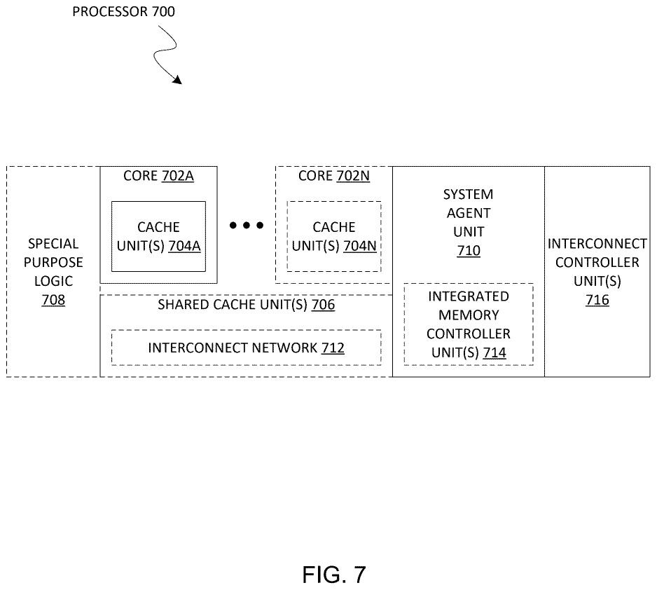

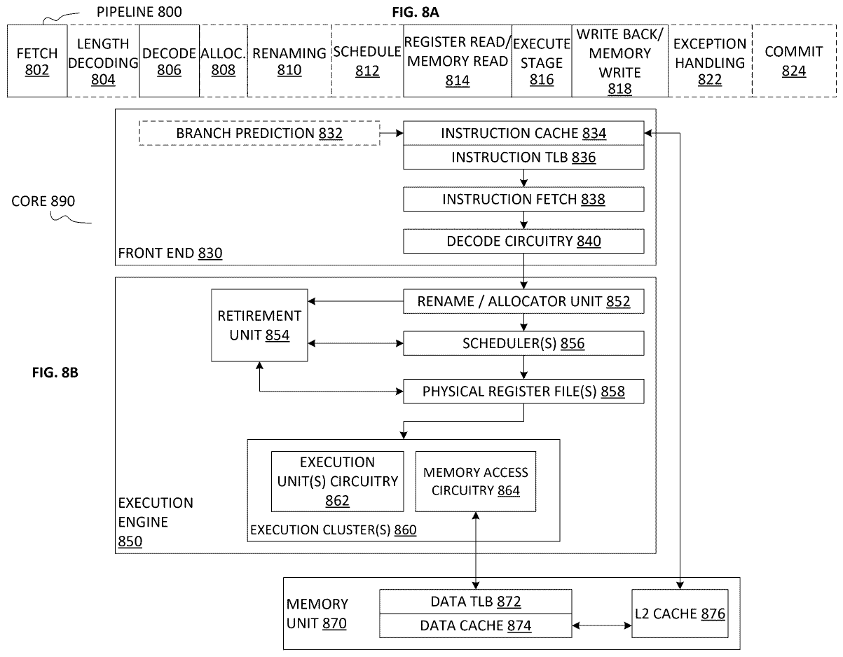

In some embodiments, circuitry of processor 110 is adapted from, and/or is incorporated with, any of various suitable processor architectures. By way of illustration and not limitation, any of various suitable embodiments of processor 110 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

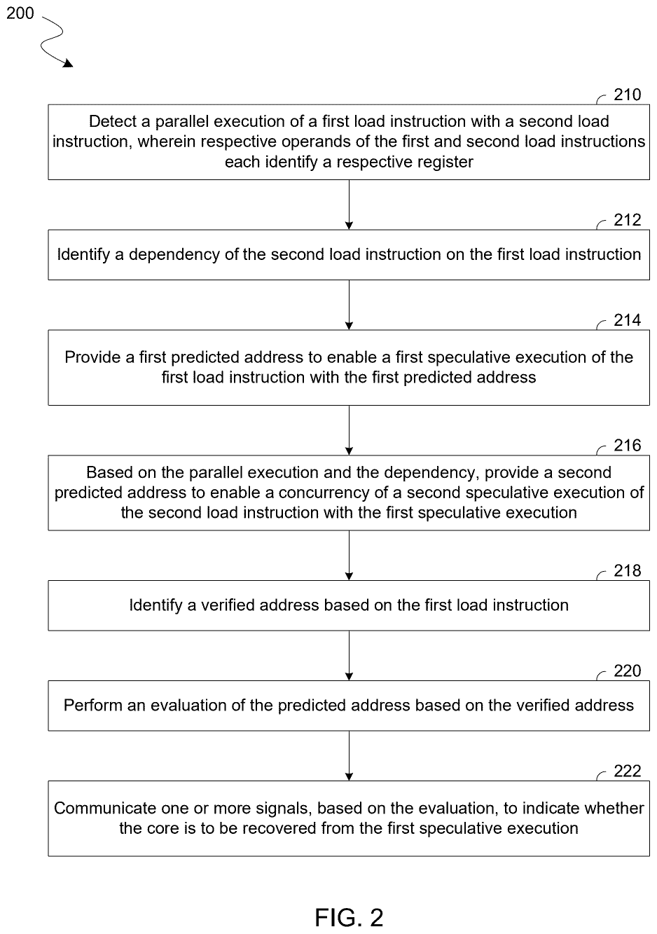

FIG. 2 shows a method 200 for facilitating parallel execution of microoperations using predicted addresses according to an embodiment. Method 200 illustrates one example of an embodiment wherein the value of an address operand is predicted for an earlier uop of a sequence, and another predicted value is provided for a corresponding address operand of a later, dependent uop of said sequence. Operations such as those of method 200 are performed with any of various combinations of suitable hardware (e.g., circuitry), firmware and/or executing software which, for example, provide some or all of the functionality of processor 110.

As shown in FIG. 2, method 200 comprises (at 210) detecting that an execution of a first load instruction is to be (e.g., detecting that it is expected to be) in parallel with an execution of a second load instruction. For example, the first load instruction and the second load instruction are respective micro-operations (uops) of a micro-operation (uop) sequence, in some embodiments.

Method 200 further comprises (at 212) identifying a dependency of the second load instruction on the first load instruction. For example, such a dependency is based on the condition of a first operand (referred to herein as a “first address operand”) of the first load instruction identifying a first register, and a second operand (referred to herein as a “second address operand”) of the second load instruction identifying a second register, wherein the first load instruction precedes the second load instruction in a program sequence, and wherein a value at the second register is to be calculated or otherwise determined based on another value at the first register. For example, the identifying at 212 comprises detecting that the value of the second register is to be calculated with another instruction which, in the program sequence, is between the first load instruction and the second load instruction.

Method 200 further comprises (at 214) providing a first predicted address—e.g., a prediction of a value in the register identified by the first address operand—to enable a first speculative execution of the first load instruction with the first predicted address. For example, the predicted value is provided to an entry of a load buffer, wherein the entry buffers the first load instruction in preparation for a later speculative execution thereof. In an embodiment, the load buffer corresponds to (e.g., is coupled to feed uops to, or is included in) a first load pipeline which is to execute the first load instruction.

Based on the parallel execution and the dependency, method 200 further provides a second predicted address (at 216)—e.g., different than the first predicted address—to enable a concurrency of the first speculative execution with a second speculative execution of the second load instruction. In one such embodiment, the first speculative execution and the second load instruction comprise respective memory accesses which are each underway during the same cycle of a processor core with which method 200 is performed. In some embodiments, speculative execution of the second load instruction is enabled prior to an assignment of a physical register to serve as a destination for the load by the first speculative execution.

Method 200 further comprises (at 218) identifying a verified address based on the first load instruction, and (at 220) performing an evaluation of the first predicted address based on the verified address. For example, identification of the verified address at 218 includes performing a read of the first register which is identified by the first address operand. The evaluation performed at 220 includes, for example, performing a comparison of the verified address with the first predicted address.

Based on the evaluation performed at 220, method 200 (at 222) communicates one or more signals which indicate whether a processor core, at which operations of method 200 are performed, is to be recovered from the first speculative execution. For example, where the evaluation determines that the first predicted address incorrectly predicts the first verified address, method 200 communicates one or more signals, at 222, to recover the processor core from both the first speculative execution and the second speculative execution.

In an illustrative scenario according to one embodiment, communicating the one or more signals at 222 includes, or is otherwise based on, the detecting of a condition wherein the evaluation at 220 has completed while the first speculative execution is underway. In one such embodiment, where the evaluation at 220 indicates a correct prediction of the verified address, method 200 communicates the one or more signals at 222, based on the condition, to indicate that a writeback, based on a load of the first address operand value, is to be permitted. Alternatively, where the evaluation at 220 indicates an incorrect prediction of the verified address, method 200 instead communicates one or more other signals, based on the condition, to interrupt the first speculative execution, and to replace the first predicted address with the verified address. For example, method 200 substitutes the verified address for the first predicted address to enable a non-speculative execution of the first load instruction with the verified address. In some embodiments, where the evaluation at 220 indicates an incorrect prediction of the verified address, method 200 further communicates another one or more signals at 222 to further replace the second predicted address—e.g., at a second load buffer—with a second verified address to enable a non-speculative execution of the second load instruction with the verified address.

In another illustrative scenario according to some embodiments, communicating the one or more signals at 222 includes, or is otherwise based on, the detecting of a condition wherein the evaluation performed at 220 has completed before a commencement of the first speculative execution. In one such embodiment, method 200 communicates one or more signals at 222, based on the condition, to replace the first predicted address with the verified address—e.g., at a first load buffer—to enable a non-speculative execution of the first load instruction with the verified address. In some embodiments, method 200 further communicates another one or more signals, based on the condition, to further replace the second predicted address—e.g., at a second load buffer—with a second verified address to enable a non-speculative execution of the second load instruction with the verified address.

In still another illustrative scenario according to some embodiments, communicating the one or more signals at 222 includes, or is otherwise based on, the detecting of a condition wherein the first speculative execution has completed before the evaluation. In one such embodiment, where the evaluation at 220 indicates a correct prediction of the verified address, method 200 communicates the one or more signals at 222, based on the condition, to indicate that a writeback of the load is correct. Alternatively, where the evaluation at 220 indicates an incorrect prediction of the verified address, method 200 instead communicates one or more other signals, based on the condition, to initiate a recovery of the processor core from the first speculative execution. In one such embodiment, incorrect prediction of the verified address further causes method 200 to communicate another one or more signals at 222 to initiate a recovery of the processor core from the second speculative execution.

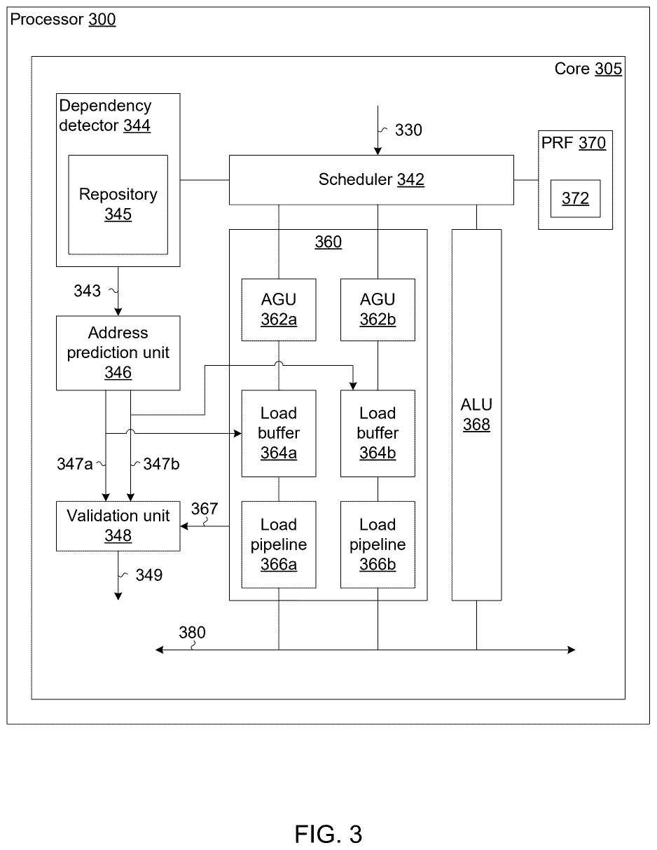

FIG. 3 shows a processor 300 which executes a load microoperation (uop) and a dependent load uop, in parallel, each based on a respective predicted address value according to an embodiment. Processor 300 illustrates features of one example embodiment wherein predicted address values enable concurrent speculative execution of load uops, where the value of an address operand of one such load uop is to depend upon the value of am address operand of another such load uop. In some embodiments, processor 300 provides functionality such as that of processor 110—e.g., wherein operations of method 200 are performed with some or all of processor 300.

As shown in FIG. 3, a core 305 of processor 300 comprises a scheduler 342, a dependency detector 344, an address prediction unit 346 and a validation unit 348 which, for example, correspond functionally of scheduler 142, dependency detector 144, address prediction unit 146, and validation unit 148 (respectively). In an embodiment, scheduler 342 is coupled to receive micro-operations (uops) 330 which, for example, are generated by an instruction decoding such at that performed at front-end unit 120. Scheduler 342 variously schedules uops 330 each to be provided to a respective one of multiple sets of execution resources of core 305—e.g., wherein said resource sets are configured to execute respective uops in parallel with each other.

By way of illustration and not limitation, one such resource set comprises ALU 368, and two other such resource sets are provided each by a different respective execution path of memory order unit 360. In the example embodiment shown, memory order unit 360 and ALU 368 are coupled in parallel with each other between scheduler 342 and one or more interconnect structures (such as the illustrative interconnect 380 shown) by which data is to be loaded, stored or otherwise provided to any of various suitable processor resources. Some examples of such processor resources include, but are not limited to, a cache, a system memory, a physical register file (PRF) 370 and/or the like.

In one such embodiment, memory order unit 360 comprises AGUs 362a, 362b (such as AGUs 162), wherein functionality such as that of load circuitry 164 is provided at memory order unit 360 with a load buffers 364a, 364b and with load pipelines 366a, 366b. In the example embodiment shown, AGUs 362a, 362b, load buffers 364a, 364b and load pipelines 366a, 366b are configured to provide two parallel paths of uop execution. For example, AGU 362a is coupled to read, calculate, or otherwise verify the value of a first address operand for a first load uop which is to be executed with load pipeline 366a, wherein load buffer (LB) 364b buffers the first load uop while it awaits such execution. Similarly, AGU 362b is coupled to read, calculate, or otherwise verify the value of a second address operand for a second load uop which is to be executed with load pipeline 366b, wherein the second load uop is buffered at LB 364b while awaiting such execution.

In some embodiments, dependency detector 344 is coupled to snoop, receive or otherwise detect some or all of uops 330, and to identify one or more dependency relationships (if any) each between a respective two such uops. For example, dependency detector 344 provides functionality to detect, for a given two uops, whether one such micro-operation (uop) is dependent upon the other such uop—e.g., wherein a first load uop is identified having a first address operand, the value of which is to be a basis for the value of a second address operand of a second (subsequent) load uop. Dependency detector 344 further detects, for example, that the first address operand and the second address operand identify respective registers which are each to provide a respective address of a corresponding location from which information is to be loaded. In an embodiment, dependency detector 344 further detects whether scheduler 342 (or any of various other suitable circuit resources) has allocated the two uops each to be provided to a different respective set of execution resources.

In one such embodiment, dependency detector 344 includes, or is otherwise coupled to access, a repository 345 of instruction dependency information. For example, repository 345 is to provide a table (or other suitable data structure), entries of which are each to correspond to a respective pair of uops which have a dependency relationship. Based on the detection of a uop dependency, dependency detector 344 generates, updates or otherwise accesses an entry of repository 345 to provide instruction dependency information for a corresponding pair of uops. By way of illustration and not limitation, such an entry of repository 345 includes or otherwise identifies some or all of a reference load uop, a corresponding dependent load uop, and—in some embodiments-one or more operands (e.g., address operands) which are the subject of the uop dependency.

In one such embodiment, dependency detector 344 provides to address prediction unit 346 an indication 343 of one or more address operands which are the basis of a uop dependency. Based on the one or more operands communicated by indication 343, address prediction unit 346 generates identifiers 347a, 347b each of a respective predicted address value—i.e., a respective prediction of the yet-to-be verified value of a corresponding address operand indicated to address prediction unit 346 by dependency detector 344 via indication 343. In an embodiment, generating such a predicted address includes operations which, for example, are adapted from one or more conventional prediction techniques including, but not limited to, any of various suitable stride-based address prediction algorithms. However, some embodiments are not limited with respect to a particular technique by which a given predicted address is generated or otherwise made available by address prediction unit 346.

In an illustrative scenario according to one embodiment, a first load uop and a second load uop (which is subsequent to, and which has an address dependency on, the first load uop) are to be executed, in parallel with each other, with load pipeline 366a and load pipeline 366b, respectively. While verification of a first address operand of the first load uop by AGU 362a is pending, address prediction unit 346 provides to load buffer 364a an identifier 347a of a first predicted value for the first address operand. Such provisioning of the first predicted value enables debuffering of the first load uop from LB 364a for speculative execution by load pipeline 366a. Furthermore, while verification of a second address operand of the second load uop by AGU 362b is pending, address prediction unit 346 similarly provides to load buffer 364b an identifier 347b of a second predicted value for the second address operand. Such provisioning of the second predicted value enables debuffering of the second load uop from LB 364b for speculative execution by load pipeline 366b—e.g., wherein the speculative execution which is enabled includes the first load uop and the second load uop concurrently executing with each other, at least at some point. In an example embodiment, the first predicted operand value is provided to the first load uop in an entry of load buffer 364a (and/or the second predicted operand value is provided to the second load uop in an entry of load buffer 364b) before a physical register 372 of PRF 370 receives a value which is to be calculated based on the yet-to-be-verified value of the second address operand.

At some point after the provisioning of the predicted address values to load buffers 364a, 364b, AGU 362a generates a verified (correct) value of the first address operand, and/or AGU 362b generates a verified value of the second address operand. Each such verified address value is communicated via a signal 367 to validation unit 348, which performs an evaluation that, for example, compares a given one such predicted address value to its corresponding verified address value. Based on the evaluation, validation unit 348 generates one or more signals (such as the illustrative signal 349 shown) which specify or otherwise indicate, for example, whether an incorrectly predicted address value (if any) is to be replaced with the verified address value, whether the execution of a uop is to be stopped, whether core 305 is to be recovered from a completed speculative execution, whether a load writeback is correct, or the like.

In some embodiments, circuitry of processor 300 is adapted from, and/or is incorporated with, any of various suitable processor architectures. By way of illustration and not limitation, any of various suitable embodiments of processor 300 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

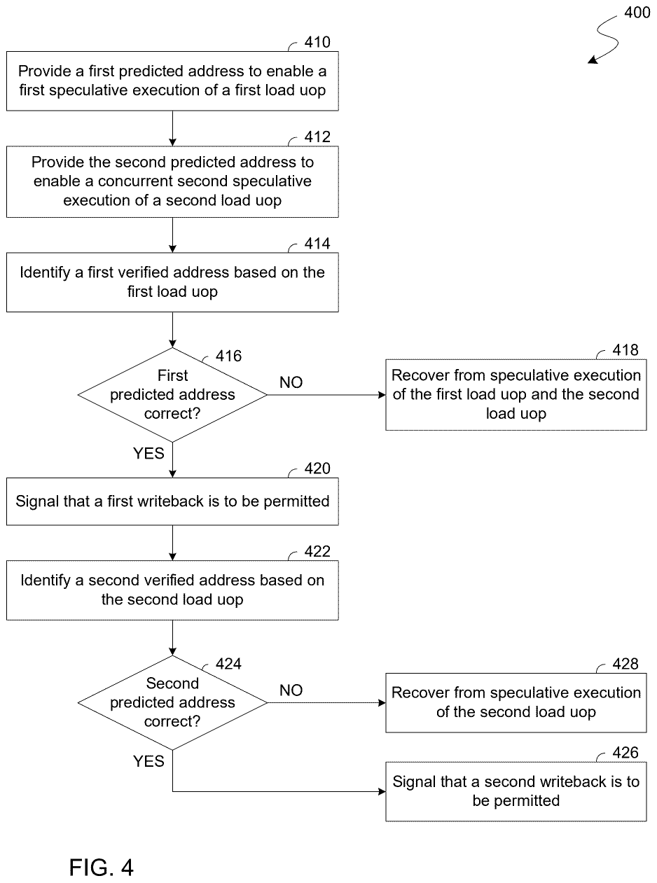

FIG. 4 shows a method 400 for executing microoperations each based on one of a respective predicted value or a respective verified value of an address operand according to an embodiment. Operations such as those of method 400 are performed with any of various combinations of suitable hardware (e.g., circuitry), firmware and/or executing software which, for example, provide functionality of processor 110 or of processor 300—e.g., wherein method 400 includes or is otherwise based on some or all operations of method 200.

As shown in FIG. 4, method 400 comprises (at 410) providing a first predicted address to enable a first speculative execution of a first load uop. Method 400 further comprises (at 412) providing a second predicted address to enable a concurrency of the first speculative execution with a second speculative execution of a second load uop. The second load uop is after the first load uop in a uop sequence, wherein a value of a first address operand of the first load uop is to be a basis for another value of a second address operand of the second load uop. For example, the uop sequence further comprises a first arithmetic uop which is between the first load uop and the second load uop, wherein the first arithmetic uop is to calculate a value of the second address operand based on a load which uses a value of the first address operand. In one such embodiment, the first address operand and the second address operand each identify a respective register, the value of which is to provide an address of a corresponding memory location from which information is to be loaded.

In an embodiment, a first predicted address and a second predicted value are loaded (at 410 and 412, respectively) each into a different respective one of load buffers (e.g., load buffers 364a, 364b) that correspond to different respective execution pipelines. In an embodiment, generating a given one such predicted address includes operations which, for example, are adapted from one or more conventional prediction techniques including, but not limited to, any of various suitable stride-based address prediction algorithms. However, some embodiments are not limited with respect to a particular technique by which a given predicted address is generated or otherwise made available for use by method 400.

Method 400 further comprises (at 414) identifying a first verified address based on the first load uop—e.g., to determine a correct value of the first address operand after the first load uop and the second load uop are buffered in preparation for potentially being executed, speculatively, based on the first predicted value and second predicted value (respectively). In an embodiment, identification of the first verified address at 414 comprises reading the value of a first register which is identified by the first address operand of the first load uop.

Method 400 further comprises performing an evaluation (at 416) to determine, based on the first confirmed address, whether the first predicted address is a correct prediction of the first verified address. Where it is determined at 416 that the first predicted address is an incorrect prediction, method 400 (at 418) generates one or more signals to recover a processor core—with which method 400 is performed—from both the first speculative execution of the first load uop and the second speculative execution of the second load uop. Alternatively (e.g., where one of both of first speculative execution nor the second speculative execution have yet to commence), the one or more signals generated at 418 are simply to replace the first predicted address with the first verified address in a first load buffer, and/or to replace the second predicted address with the second verified address in a second load buffer.

In various embodiments, the uop sequence further comprises the above-described first arithmetic uop, and a second arithmetic uop which is after the second load uop, and is to depend on a value of information which is loaded by execution of the second load uop. In one such embodiment, method 400 further generates one or more signals at 418 to recover the processor core from a speculative execution of the first arithmetic uop, and (for example) from a speculative execution of the second arithmetic uop.

Where it is instead determined at 416 that the first predicted address is a correct prediction, method 400 generates one or more signals (at 420) to indicate that a first writeback (actual or expected) based on the first speculative execution is to be permitted. In an embodiment, method 400 further identifies a second verified address (at 422) based on the second load uop. For example, the second verified address is identified at 422 by reading the value of a second register which is identified by the second address operand of the second load uop, wherein the value is calculated based on information which is loaded by an execution (speculative or non-speculative) of the first load uop.

Method 400 further comprises performing an evaluation (at 424) to determine, based on the second confirmed address, whether the second predicted address is a correct prediction of the second verified address. Where it is determined at 424 that the second predicted address is an incorrect prediction, method 400 (at 428) generates one or more signals to recover the processor core from the second speculative execution of the second load uop. Alternatively (e.g., where the second speculative execution have yet to commence), the one or more signals generated at 428 are simply to replace the second predicted address with the second verified address in a second load buffer. Where it is instead determined at 424 that the second predicted address is a correct prediction, method 400 generates one or more signals (at 426) to indicate that a second writeback (actual or expected) based on the second speculative execution is to be permitted.

In some embodiments, the recovering at 418 is conditioned upon an additional evaluation (not shown) that the first speculative execution and the second speculative execution have each completed. Alternatively or in addition, the recovering at 428 is conditioned upon an additional evaluation (not shown) that the second speculative execution has completed. In an alternative scenario, where one or each of the first speculative execution and/or the second speculative execution has commenced, but has not yet completed, one or more signals are generated—e.g., at 418 or at 428—to interrupt the underway speculative execution, and to replace a predicted address with the corresponding verified address, thereby enabling a non-speculative execution of the load uop in question.

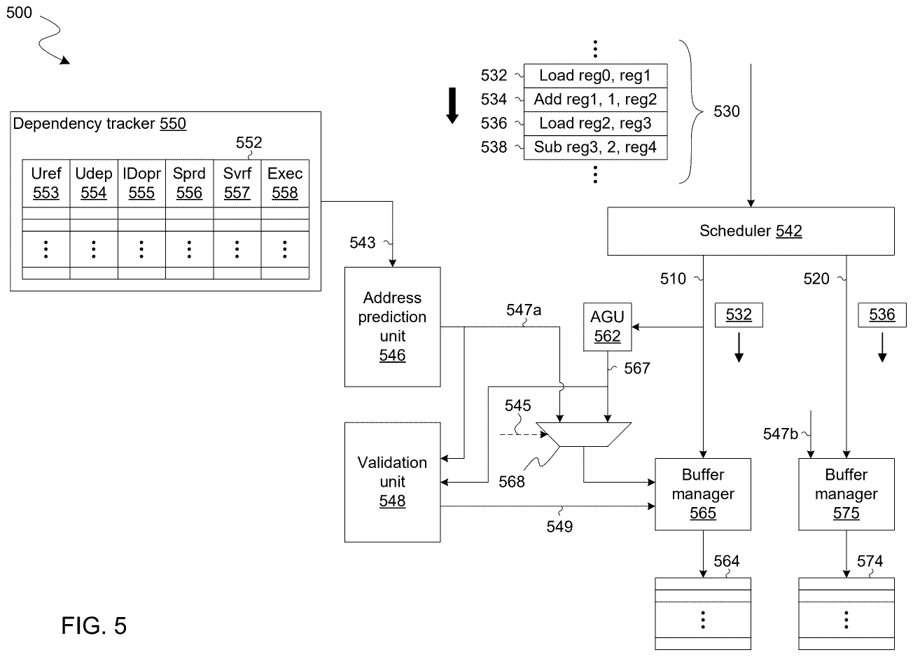

FIG. 5 shows a processor 500 which selectively provisions predicted addresses for respective microoperations according to an embodiment. In some embodiments, processor 500 provides functionality such as that of processor 110 or of processor 300—e.g., wherein operations of one of methods 200, 400 are performed with some or all of processor 500.

As shown in FIG. 5, processor 500 comprises a scheduler 542, a dependency tracker 550, an address prediction unit 546 and a validation unit 548 which, for example, correspond functionally of scheduler 142, dependency detector 144, address prediction unit 146, and validation unit 148 (respectively). Furthermore, a first set of execution resources of processor 500 comprises an AGU 562, a buffer manager 565, and a buffer 564—e.g., wherein AGU 562 and buffer 564 correspond functionally to AGU 362a and load buffer 364a. Further still, a second set of execution resources—coupled in parallel with the first set of execution resources—comprises a buffer manager 575 and a buffer 574—e.g., wherein buffer 574 correspond functionally to load buffer 364b. In one such embodiment, buffer manager 565 manages the buffering and debuffering of uops which buffer 564 feeds into a first load pipeline (not shown) of processor 500, wherein buffer manager 575 manages the buffering and debuffering of other uops which buffer 574 feeds into a second load pipeline (not shown) of processor 500.

In an embodiment, scheduler 542 is coupled to receive micro-operations (uops) 530 which, for example, are generated by an instruction decoding such at that performed at front-end unit 120. Scheduler 542 variously schedules uops 530 each to be provided to a respective one of multiple sets of execution resources of processor 500—e.g., wherein said resource sets are configured to execute respective uops in parallel with each other.

The uop sequence 530 illustrates one example scenario wherein a first load uop is followed by a second load uop, wherein a first operand of the first load uop specifies or otherwise indicates a first address value, and wherein a second operand of the second load uop specifies or otherwise indicates a second address value that is to be determined based on the first address value. By way of illustration and not limitation, uop sequence 530 comprises a load uop 532 (Load reg0, reg1) which, when executed, is to load—to a physical register reg1—a value which is available at a memory location indicated by the value in another physical register reg0. Furthermore, uop sequence 530 comprises an arithmetic uop 534 (Add reg1, 1, reg2) which, when executed, is to provide to a physical register reg2 a value which is equal to a sum of one (1) and the value loaded into physical register reg1. Further still, uop sequence 530 comprises another load uop 536 (Load reg2, reg3) which, when executed, is to load—to a physical register reg3—a value which is available at a memory location indicated by the value in the physical register reg2. Although some embodiments are not limited in this regard, uop sequence 530 further comprises another arithmetic uop 538 (Sub reg3, 2, reg4) which, when executed, is to provide to a physical register reg4 a value which is equal to a difference between the value in physical register reg3 and the integer two (2).

In one such embodiment, dependency tracker 550 is coupled to snoop or otherwise detect that uop 536 is dependent upon uop 532 (and follows uop 532 in sequence 530), that scheduler 542 has directed uop 532 along a path 510 to the first set of execution resources, and that scheduler 542 has further directed uop 536 along a parallel path 520 to the second set of execution resources. Based on such detecting, dependency tracker 550 accesses a table 552 of instruction dependency information, the table 552 comprising entries which each indicate a correspond dependency between a respective two uops.

In the example embodiment shown, a given entry of table 552 comprises a respective field 553 to include or otherwise identify a reference uop (Uref) from which a respective other uop depends. Furthermore, said entry of table 552 comprises a field 554 to include or otherwise identify a dependent uop (Udep) corresponding to the reference uop in question. Further still, said entry of table 552 comprises a field 555 to indicate one or more address operands which are a basis for a dependency between the corresponding uops Uref, Udep. In some embodiments, a given entry of table 552 further comprises a field 556 to provide a corresponding address prediction status—e.g., to specify or otherwise indicate whether a predicted value of a respective address operand has been determined. Alternatively or in addition, said entry of table 552 comprises a field 557 to indicate a corresponding address verification status—e.g., to specify or otherwise indicate whether a verified (correct) value of the address operand has been generated. Alternatively or in addition, said entry of table 552 comprises a field 558 a corresponding execution status—e.g., to specify or otherwise indicate whether, for one or each of the reference uop (Uref) and the dependent uop (Udep), an execution of the uop in question has begun, is currently underway, or has completed.

In one such embodiment, dependency detector 544 provides to address prediction unit 546 an indication 543 of the register reg0 identified by the address operand of load uop 532, and of the register reg2 identified by the address operand of load uop 536. Based on indication 543, address prediction unit 546 generates an identifier 547a of a first predicted address value—i.e., a prediction of the value in register reg0. Further based on indication 543, address prediction unit 546 generates another identifier 547b of a second predicted address value—i.e., a prediction of the value in register reg2. In an embodiment, identifiers 547a, 547b are communicated to validation unit 548—e.g., prior to the generation of corresponding verified address values based on load uops 532, 536. In an embodiment, identifiers 547a, 547b are further communicated each to respective selector circuitry—e.g., wherein a selector circuit 568 is operable to select between identifier 547a and a corresponding verified address 567 for load uop 532. In one such embodiment, another selector circuit (not shown) is similarly operable to select between identifier 547b and a corresponding verified address for load uop 536.

In the example embodiment shown, identifier 547a is provided to a selector circuit 568 which is operable, responsive to a control signal 545, to select between providing to buffer manager 565 the identifier 547 of a first predicted address value, and providing to buffer manager 565 a corresponding verified address 567 which AGU 562 is to generate for uop 532. In an embodiment, the first predicted address value is provided to buffer manager 565 due to an at least temporary unavailability of the verified address 567. In turn, buffer manager 565 incudes the first predicted address value, along with the rest of uop 532, in an entry of buffer 564.

Similarly, the identifier 547b of a second predicted address value is provided to buffer manager 575 due to an at least temporary unavailability of a verified address operand for load uop 536. In one such embodiment, identifier 547b is provided to buffer manager 575 via other selector circuitry (not shown) similar to that of selector circuit 568. In turn, buffer manager 575 incudes the second predicted address value, along with the rest of uop 536, in an entry of buffer 574. In an embodiment, provisioning of predicted address values via identifiers 547a, 547b enables load uops 532, 536 each to be debuffered (from respective load buffers 564, 574) for speculative execution concurrent with each other.

At some point after the provisioning of the respective predicted address values to load buffers 564, 574, AGU 562 generates a first verified (correct) value of the first address operand. For example, a verified address 567 is provided to validation unit 548, which performs a first evaluation that compares the first predicted address value to its corresponding first verified address value. Furthermore, validation unit 548 similarly receives and evaluates a second verified value of the second address operand. Based on the evaluation of the first predicted address value and/or the evaluation of the second predicted address value, validation unit 548 generates one or more signals (such as the illustrative signal 549 shown) which specify or otherwise indicate, for example, whether an incorrectly predicted address value (if any) is to be replaced with a corresponding verified address value, whether the execution of a uop is to be stopped, whether processor 500 is to be recovered from a completed speculative execution, whether a load writeback is correct, or the like.

In some embodiments, circuitry of processor 500 is adapted from, and/or is incorporated with, any of various suitable processor architectures. By way of illustration and not limitation, any of various suitable embodiments of processor 500 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

### Exemplary Computer Architectures.

Detailed below are describes of exemplary computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors' local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or coprocessor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or coprocessor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures-In-Order and Out-of-Order Core Block Diagram.

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry.

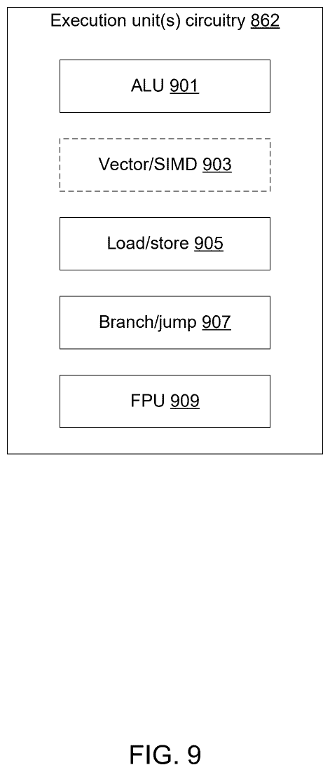

FIG. 9 illustrates examples of execution unit(s) circuitry, such as execution unit(s) circuitry 862 of FIG. 8B. As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

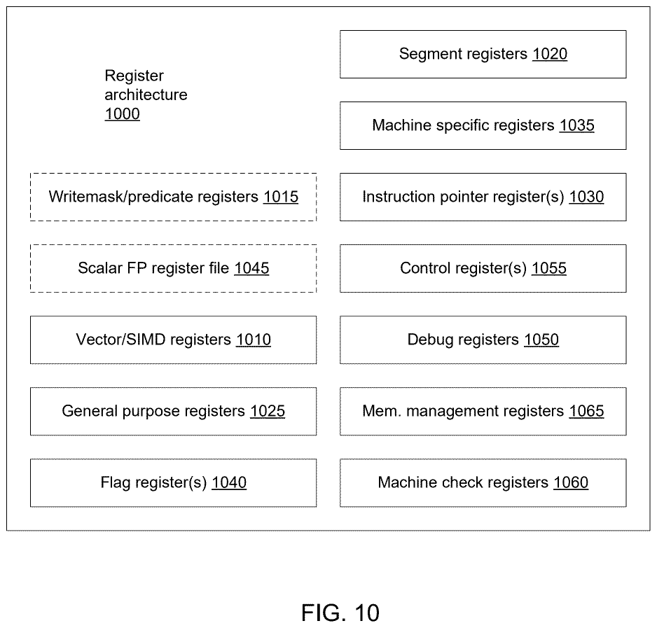

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc, and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

Techniques and architectures for enabling speculative execution of an instruction are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMS, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor core comprises first circuitry to detect a parallel execution of a first load instruction with a second load instruction each of an instruction sequence, identify a dependency of the second load instruction on the first load instruction, wherein a first operand of the first load instruction identifies a first register, the second operand identifies a second register, and a value of the second register is to depend on another value of the first register, second circuitry coupled to the first circuitry, the second circuitry to provide a first predicted address to enable a first speculative execution of the first load instruction, and based on the parallel execution and the dependency, provide a second predicted address to enable a concurrency of a second speculative execution of the second load instruction with the first speculative execution of the first load instruction.

In one or more second embodiments, further to the first embodiment, the first speculative execution and the second load instruction comprise respective memory accesses which are each underway during a first cycle of the processor core.

In one or more third embodiments, further to the first embodiment or the second embodiment, the processor core further comprises third circuitry coupled to the second circuitry, the third circuitry to identify a first verified address based on the first load instruction, perform a first evaluation to determine, based on the first verified address, whether the first predicted address correctly predicts the first verified address, and where the first evaluation determines that the first predicted address incorrectly predicts the first verified address, communicate one or more signals to recover the processor core from both the first speculative execution and the second speculative execution.

In one or more fourth embodiments, further to the third embodiment, the instruction sequence further comprises a first arithmetic instruction which is between the first load instruction and the second load instruction, and where the first evaluation determines that the first predicted address incorrectly predicts the first verified address, the one or more signals are further to recover the processor core from a speculative execution of the first arithmetic instruction.

In one or more fifth embodiments, further to the fourth embodiment, the instruction sequence further comprises a second arithmetic instruction which is after the second load instruction, and where the first evaluation determines that the first predicted address incorrectly predicts the first verified address, the one or more signals are further to recover the processor core from a speculative execution of the second arithmetic instruction.

In one or more sixth embodiments, further to the third embodiment, the third circuitry is further to identify a second verified address based on the second load instruction, where the first evaluation determines that the first predicted address correctly predicts the first verified address perform a second evaluation to determine whether the second predicted address correctly predicts the second verified address, and where the second evaluation determines that second predicted address incorrectly predicts the second verified address, communicate another one or more signals to recover the processor core from the second speculative execution.

In one or more seventh embodiments, further to any of the first through third embodiments, the processor core further comprises third circuitry coupled to the second circuitry, the third circuitry to identify a first verified address based on the first load instruction, perform a first evaluation to determine, based on the first verified address, whether the first predicted address correctly predicts the first verified address, and where the first evaluation determines that the first predicted address incorrectly predicts the first verified address determine whether the second speculative execution is currently underway, and where the second speculative execution is determined to be currently underway interrupt the second speculative execution, and replace the second predicted address with a second verified address to enable a non-speculative execution of the second load instruction with the second verified address.

In one or more eighth embodiments, further to any of the first through third embodiments, the processor core further comprises third circuitry coupled to the second circuitry, the third circuitry to identify a first verified address based on the first load instruction, detect a first condition wherein the first predicted address incorrectly predicts the first verified address, and wherein the first speculative execution yet to commence, and based on the first condition, replace the first predicted address with the first verified address to enable a non-speculative execution of the first load instruction.

In one or more ninth embodiments, further to the eighth embodiment, the third circuitry is further to identify a second verified address based on the second load instruction, detect a second condition wherein the second predicted address incorrectly predicts the second verified address, and wherein the second speculative execution yet to commence, and based on the second condition, replace the second predicted address with the second verified address to enable a non-speculative execution of the second load instruction.

In one or more tenth embodiments, a method at a processor core comprises detecting a parallel execution of a first load instruction with a second load instruction each of an instruction sequence, identifying a dependency of the second load instruction on the first load instruction, wherein a first operand of the first load instruction identifies a first register, the second operand identifies a second register, and a value of the second register is to depend on another value of the first register, providing a first predicted address to enable a first speculative execution of the first load instruction, and based on the parallel execution and the dependency, providing a second predicted address to enable a concurrency of a second speculative execution of the second load instruction with the first speculative execution of the first load instruction.

In one or more eleventh embodiments, further to the tenth embodiment, the first speculative execution and the second load instruction comprise respective memory accesses which are each underway during a first cycle of the processor core.

In one or more twelfth embodiments, further to the tenth embodiment or the eleventh embodiment, the method further comprises identifying a first verified address based on the first load instruction, performing a first evaluation to determine, based on the first verified address, whether the first predicted address correctly predicts the first verified address, and where the first evaluation determines that the first predicted address incorrectly predicts the first verified address, communicating one or more signals to recover the processor core from both the first speculative execution and the second speculative execution.

In one or more thirteenth embodiments, further to the twelfth embodiment, the instruction sequence further comprises a first arithmetic instruction which is between the first load instruction and the second load instruction, and where the first evaluation determines that the first predicted address incorrectly predicts the first verified address, the one or more signals are further to recover the processor core from a speculative execution of the first arithmetic instruction.

In one or more fourteenth embodiments, further to the thirteenth embodiment, the instruction sequence further comprises a second arithmetic instruction which is after the second load instruction, and where the first evaluation determines that the first predicted address incorrectly predicts the first verified address, the one or more signals are further to recover the processor core from a speculative execution of the second arithmetic instruction.

In one or more fifteenth embodiments, further to the twelfth embodiment, the method further comprises identifying a second verified address based on the second load instruction, where the first evaluation determines that the first predicted address correctly predicts the first verified address performing a second evaluation to determine whether the second predicted address correctly predicts the second verified address, and where the second evaluation determines that second predicted address incorrectly predicts the second verified address, communicating another one or more signals to recover the processor core from the second speculative execution.

In one or more sixteenth embodiments, further to any of the tenth through twelfth embodiments, the method further comprises identifying a first verified address based on the first load instruction, performing a first evaluation to determine, based on the first verified address, whether the first predicted address correctly predicts the first verified address, and where the first evaluation determines that the first predicted address incorrectly predicts the first verified address determining whether the second speculative execution is currently underway, and where the second speculative execution is determined to be currently underway interrupting the second speculative execution, and replacing the second predicted address with a second verified address to enable a non-speculative execution of the second load instruction with the second verified address.

In one or more seventeenth embodiments, further to any of the tenth through twelfth embodiments, the method further comprises identifying a first verified address based on the first load instruction, detecting a first condition wherein the first predicted address incorrectly predicts the first verified address, and wherein the first speculative execution yet to commence, and based on the first condition, replacing the first predicted address with the first verified address to enable a non-speculative execution of the first load instruction.

In one or more eighteenth embodiments, further to the seventeenth embodiment, the method further comprises identifying a second verified address based on the second load instruction, detecting a second condition wherein the second predicted address incorrectly predicts the second verified address, and wherein the second speculative execution yet to commence, and based on the second condition, replacing the second predicted address with the second verified address to enable a non-speculative execution of the second load instruction.

In one or more nineteenth embodiments, a system comprises a memory, a memory controller, a processor core coupled to the memory via the memory controller, the processor core comprising first circuitry to detect a parallel execution of a first load instruction with a second load instruction each of an instruction sequence, identify a dependency of the second load instruction on the first load instruction, wherein a first operand of the first load instruction identifies a first register, the second operand identifies a second register, and a value of the second register is to depend on another value of the first register, second circuitry coupled to the first circuitry, the second circuitry to provide a first predicted address to enable a first speculative execution of the first load instruction, and based on the parallel execution and the dependency, provide a second predicted address to enable a concurrency of a second speculative execution of the second load instruction with the first speculative execution of the first load instruction.

In one or more twentieth embodiments, further to the nineteenth embodiment, the first speculative execution and the second load instruction comprise respective memory accesses which are each underway during a first cycle of the processor core.

In one or more twenty-first embodiments, further to the nineteenth embodiment or the twentieth embodiment, the processor core further comprises third circuitry coupled to the second circuitry, the third circuitry to identify a first verified address based on the first load instruction, perform a first evaluation to determine, based on the first verified address, whether the first predicted address correctly predicts the first verified address, and where the first evaluation determines that the first predicted address incorrectly predicts the first verified address, communicate one or more signals to recover the processor core from both the first speculative execution and the second speculative execution.

In one or more twenty-second embodiments, further to the twenty-first embodiment, the instruction sequence further comprises a first arithmetic instruction which is between the first load instruction and the second load instruction, and where the first evaluation determines that the first predicted address incorrectly predicts the first verified address, the one or more signals are further to recover the processor core from a speculative execution of the first arithmetic instruction.

In one or more twenty-third embodiments, further to the twenty-second embodiment, the instruction sequence further comprises a second arithmetic instruction which is after the second load instruction, and where the first evaluation determines that the first predicted address incorrectly predicts the first verified address, the one or more signals are further to recover the processor core from a speculative execution of the second arithmetic instruction.

In one or more twenty-fourth embodiments, further to the twenty-first embodiment, the third circuitry is further to identify a second verified address based on the second load instruction, where the first evaluation determines that the first predicted address correctly predicts the first verified address perform a second evaluation to determine whether the second predicted address correctly predicts the second verified address, and where the second evaluation determines that second predicted address incorrectly predicts the second verified address, communicate another one or more signals to recover the processor core from the second speculative execution.

In one or more twenty-fifth embodiments, further to any of the nineteenth through twenty-first embodiments, the processor core further comprises third circuitry coupled to the second circuitry, the third circuitry to identify a first verified address based on the first load instruction, perform a first evaluation to determine, based on the first verified address, whether the first predicted address correctly predicts the first verified address, and where the first evaluation determines that the first predicted address incorrectly predicts the first verified address determine whether the second speculative execution is currently underway, and where the second speculative execution is determined to be currently underway interrupt the second speculative execution, and replace the second predicted address with a second verified address to enable a non-speculative execution of the second load instruction with the second verified address.

In one or more twenty-sixth embodiments, further to any of the nineteenth through twenty-first embodiments, the processor core further comprises third circuitry coupled to the second circuitry, the third circuitry to identify a first verified address based on the first load instruction, detect a first condition wherein the first predicted address incorrectly predicts the first verified address, and wherein the first speculative execution yet to commence, and based on the first condition, replace the first predicted address with the first verified address to enable a non-speculative execution of the first load instruction.

In one or more twenty-seventh embodiments, further to the twenty-sixth embodiment, the third circuitry is further to identify a second verified address based on the second load instruction, detect a second condition wherein the second predicted address incorrectly predicts the second verified address, and wherein the second speculative execution yet to commence, and based on the second condition, replace the second predicted address with the second verified address to enable a non-speculative execution of the second load instruction.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor core comprising:
first circuitry to:
detect a parallel execution of a first load instruction with a second load instruction each of an instruction sequence;
identify a dependency of the second load instruction on the first load instruction, wherein a first operand of the first load instruction identifies a first register, the second operand identifies a second register, and a value of the second register is to depend on another value of the first register;
second circuitry coupled to the first circuitry, the second circuitry to:
provide a first predicted address to enable a first speculative execution of the first load instruction; and
based on the parallel execution and the dependency, provide a second predicted address to enable a concurrency of a second speculative execution of the second load instruction with the first speculative execution of the first load instruction.

2. The processor core of claim 1, wherein the first speculative execution and the second load instruction comprise respective memory accesses which are each underway during a first cycle of the processor core.

3. The processor core of claim 1, further comprising third circuitry coupled to the second circuitry, the third circuitry to:
identify a first verified address based on the first load instruction;
perform a first evaluation to determine, based on the first verified address, whether the first predicted address correctly predicts the first verified address; and
where the first evaluation determines that the first predicted address incorrectly predicts the first verified address, communicate one or more signals to recover the processor core from both the first speculative execution and the second speculative execution.

4. The processor core of claim 3, wherein
the instruction sequence further comprises a first arithmetic instruction which is between the first load instruction and the second load instruction; and
where the first evaluation determines that the first predicted address incorrectly predicts the first verified address, the one or more signals are further to recover the processor core from a speculative execution of the first arithmetic instruction.

5. The processor core of claim 4, wherein
the instruction sequence further comprises a second arithmetic instruction which is after the second load instruction; and
where the first evaluation determines that the first predicted address incorrectly predicts the first verified address, the one or more signals are further to recover the processor core from a speculative execution of the second arithmetic instruction.

6. The processor core of claim 3, wherein the third circuitry is further to:
identify a second verified address based on the second load instruction;
where the first evaluation determines that the first predicted address correctly predicts the first verified address:
perform a second evaluation to determine whether the second predicted address correctly predicts the second verified address; and
where the second evaluation determines that second predicted address incorrectly predicts the second verified address, communicate another one or more signals to recover the processor core from the second speculative execution.

7. The processor core of claim 1, further comprising third circuitry coupled to the second circuitry, the third circuitry to:
identify a first verified address based on the first load instruction;
perform a first evaluation to determine, based on the first verified address, whether the first predicted address correctly predicts the first verified address; and
where the first evaluation determines that the first predicted address incorrectly predicts the first verified address:
determine whether the second speculative execution is currently underway; and
where the second speculative execution is determined to be currently underway:
interrupt the second speculative execution; and
replace the second predicted address with a second verified address to enable a non-speculative execution of the second load instruction with the second verified address.

8. The processor core of claim 1, further comprising third circuitry coupled to the second circuitry, the third circuitry to:
identify a first verified address based on the first load instruction;
detect a first condition wherein the first predicted address incorrectly predicts the first verified address, and wherein the first speculative execution yet to commence; and
based on the first condition, replace the first predicted address with the first verified address to enable a non-speculative execution of the first load instruction.

9. A method at a processor core, the method comprising:
detecting a parallel execution of a first load instruction with a second load instruction each of an instruction sequence;
identifying a dependency of the second load instruction on the first load instruction, wherein a first operand of the first load instruction identifies a first register, the second operand identifies a second register, and a value of the second register is to depend on another value of the first register;
providing a first predicted address to enable a first speculative execution of the first load instruction; and
based on the parallel execution and the dependency, providing a second predicted address to enable a concurrency of a second speculative execution of the second load instruction with the first speculative execution of the first load instruction.

10. The method of claim 9, wherein the first speculative execution and the second load instruction comprise respective memory accesses which are each underway during a first cycle of the processor core.

11. The method of claim 9, further comprising:
identifying a first verified address based on the first load instruction;
performing a first evaluation to determine, based on the first verified address, whether the first predicted address correctly predicts the first verified address; and
where the first evaluation determines that the first predicted address incorrectly predicts the first verified address, communicating one or more signals to recover the processor core from both the first speculative execution and the second speculative execution.

12. The method of claim 11, wherein:
the instruction sequence further comprises a first arithmetic instruction which is between the first load instruction and the second load instruction; and
where the first evaluation determines that the first predicted address incorrectly predicts the first verified address, the one or more signals are further to recover the processor core from a speculative execution of the first arithmetic instruction.

13. The method of claim 11, further comprising:
identifying a second verified address based on the second load instruction;
where the first evaluation determines that the first predicted address correctly predicts the first verified address:
performing a second evaluation to determine whether the second predicted address correctly predicts the second verified address; and
where the second evaluation determines that second predicted address incorrectly predicts the second verified address, communicating another one or more signals to recover the processor core from the second speculative execution.

14. The method of claim 9, further comprising:
identifying a first verified address based on the first load instruction;
performing a first evaluation to determine, based on the first verified address, whether the first predicted address correctly predicts the first verified address; and
where the first evaluation determines that the first predicted address incorrectly predicts the first verified address:
determining whether the second speculative execution is currently underway; and
where the second speculative execution is determined to be currently underway:
interrupting the second speculative execution; and
replacing the second predicted address with a second verified address to enable a non-speculative execution of the second load instruction with the second verified address.

15. The method of claim 9, further comprising:
identifying a first verified address based on the first load instruction;
detecting a first condition wherein the first predicted address incorrectly predicts the first verified address, and wherein the first speculative execution yet to commence; and
based on the first condition, replacing the first predicted address with the first verified address to enable a non-speculative execution of the first load instruction.

16. A system comprising:
a memory;
a memory controller;
a processor core coupled to the memory via the memory controller, the processor core comprising:
first circuitry to:
detect a parallel execution of a first load instruction with a second load instruction each of an instruction sequence;
identify a dependency of the second load instruction on the first load instruction, wherein a first operand of the first load instruction identifies a first register, the second operand identifies a second register, and a value of the second register is to depend on another value of the first register;
second circuitry coupled to the first circuitry, the second circuitry to:
provide a first predicted address to enable a first speculative execution of the first load instruction; and
based on the parallel execution and the dependency, provide a second predicted address to enable a concurrency of a second speculative execution of the second load instruction with the first speculative execution of the first load instruction.

17. The system of claim 16, wherein the first speculative execution and the second load instruction comprise respective memory accesses which are each underway during a first cycle of the processor core.

18. The system of claim 16, the processor core further comprising third circuitry coupled to the second circuitry, the third circuitry to:
identify a first verified address based on the first load instruction;
perform a first evaluation to determine, based on the first verified address, whether the first predicted address correctly predicts the first verified address; and
where the first evaluation determines that the first predicted address incorrectly predicts the first verified address, communicate one or more signals to recover the processor core from both the first speculative execution and the second speculative execution.

19. The system of claim 18, wherein
the instruction sequence further comprises a first arithmetic instruction which is between the first load instruction and the second load instruction; and
where the first evaluation determines that the first predicted address incorrectly predicts the first verified address, the one or more signals are further to recover the processor core from a speculative execution of the first arithmetic instruction.

20. The system of claim 18, wherein the third circuitry is further to:
identify a second verified address based on the second load instruction;
where the first evaluation determines that the first predicted address correctly predicts the first verified address:
perform a second evaluation to determine whether the second predicted address correctly predicts the second verified address; and
where the second evaluation determines that second predicted address incorrectly predicts the second verified address, communicate another one or more signals to recover the processor core from the second speculative execution.
